(19) United States
(12) Patent Application Publication
(10) Pub. No.: US 2025/0383551 A1
(43) Pub. Date: Dec. 18, 2025

(54) OPTICAL BEAMSPLITTER WITH VARIABLE SPLITTING RATIO

(71) Applicant: University of Central Florida Research Foundation, Inc., Orlando, FL (US)

(72) Inventors: Ivan Divliansky, Orlando, FL (US); Oussama Mhibik, Oviedo, FL (US)

(21) Appl. No.: 19/236,695

(22) Filed: Jun. 12, 2025

Related U.S. Application Data
(60) Provisional application No. 63/659,211, filed on Jun. 12, 2024.

(51) Int. Cl. G02B 27/10

(52) U.S. Cl. CPC G02B 27/1086

(57) ABSTRACT

A beamsplitter may include one or more volume Bragg gratings (VBGs) within a volume of a material having an input face, where each of the VBGs is formed as planes of refractive index variation with periodicity along a grating vector direction at a non-zero angle relative to a normal vector of the input face, and where the material receives input beam through the input face. At least a portion of the input beam may directed into one or more diffracted beams when a Bragg condition is satisfied for any of the one or more VBGs, and at least a portion of the input beam undiffracted by the one or more VBGs may forms an undiffracted beam. Relative powers in the undiffracted beam and any of the one or more diffracted beams may be adjusted through angular and/or spectral tuning.

### CROSS-REFERENCE TO RELATED APPLICATION

The present application claims the benefit under 35 U.S.C. § 119 (e) of U.S. Provisional Application Ser. No. 63/659,211, filed Jun. 12, 2024, entitled OPTICAL BEAMSPLITTER WITH VARIABLE SPLITTING RATIO, naming Ivan Divliansky and Oussama Mhibik as inventors, which is incorporated herein by reference in the entirety.

### TECHNICAL FIELD

The present disclosure relates generally to optical beamsplitters and, more particularly, to optical beamsplitters formed from at least one volume Bragg grating.

### SUMMARY

In some embodiments, an optical beamsplitter is provided. The optical beamsplitter may include a light source providing an input beam. The optical beamsplitter may include one or more volume Bragg gratings (VBGs) within a volume of a material having an input face. Each of the one or more VBGs may be formed as planes of refractive index variation with periodicity along a grating vector direction at a non-zero angle relative to a normal vector of the input face. The material may receive the input beam through the input face. The optical beamsplitter may include a rotation stage configured to secure the volume of the material and adjust an incidence angle of the input beam on the input face. At least a portion of the input beam may be directed into one or more diffracted beams when a Bragg condition is satisfied for any of the one or more VBGs. At least a portion of the input beam undiffracted by the one or more VBGs may form an undiffracted beam. A power distribution between the undiffracted beam and the one or more diffracted beams may be adjustable by controlling the incidence angle with the rotation stage.

In some embodiments, a power of the one or more diffracted beams may be associated with a diffraction efficiency of the one or more VBGs.

In some embodiments, the one or more diffracted beams may include a single diffracted beam.

In some embodiments, an angle formed between the undiffracted beam and the single diffracted beam may range from 0 degrees to 180 degrees.

In some embodiments, a splitting ratio between the undiffracted beam and the single diffracted beam may range from 0 to 100 percent of a power of the input beam.

In some embodiments, the splitting ratio may be continuously tunable by adjusting an angle of the input face relative to the input beam.

In some embodiments, the splitting ratio may be continuously tunable by adjusting a wavelength of the input beam.

In some embodiments, the one or more VBGs may include a single VBG.

In some embodiments, the one or more VBGs may include a first VBG and a second VBG. The grating vector direction of the first VBG may be oriented along a first direction. The grating vector direction of the second VBG may be oriented along a second direction different than the first direction. The one or more diffracted beams may include two diffracted beams.

In some embodiments, the planes of refractive index variation of the first VBG and the planes of refractive index variation of the second VBG may have equivalent distributions along the respective grating vector directions.

In some embodiments, the first direction may be orthogonal to the second direction.

In some embodiments, the planes of refractive index variation of the first VBG and the planes of refractive index variation of the second VBG may have different distributions along the respective grating vector directions.

In some embodiments, the planes of refractive index variation of the first VBG and the planes of refractive index variation of the second VBG may have uniform periods along the respective grating vector directions.

In some embodiments, the one or more VBGs may include a first VBG and a second VBG. The grating vector direction of the first VBG and the grating vector direction of the second VBG may be oriented along a common direction. The planes of refractive index variation of the first VBG and the planes of refractive index variation of the second VBG may have different distributions along the respective grating vector directions. The one or more diffracted beams may include two or more diffracted beams.

In some embodiments, the material may further include an output face. The undiffracted beam may exit through the output face.

In some embodiments, at least one of the one or more diffracted beams may exit through the output face.

In some embodiments, the material may further include an additional output face at an angle with respect to the input face. At least one of the one or more diffracted beams may exit from the additional output face.

In some embodiments, an optical beamsplitter is provided. The optical beamsplitter may include one or more VBGs within a volume of a material having an input face. Each of the one or more VBGs may be formed as planes of refractive index variation with periodicity along a grating vector direction at a non-zero angle relative to a normal vector of the input face. The material may receive an input beam through the input face. The optical beamsplitter may include a light source providing the input beam. A wavelength of the input beam may be tunable to one or more selected wavelengths. At least a portion of the input beam may be diffracted as one or more diffracted beams when a Bragg condition is satisfied for any of the one or more VBGs. At least a portion of the input beam undiffracted by the one or more VBGs may form an undiffracted beam. A power distribution between the undiffracted beam and the one or more diffracted beams may be adjustable by controlling the wavelength of the input beam with the light source.

In some embodiments, a power of the one or more diffracted beams may be associated with a diffraction efficiency of the one or more VBGs.

In some embodiments, the one or more diffracted beams may include a single diffracted beam.

In some embodiments, an angle formed between the undiffracted beam and the single diffracted beam may range from 0 to 180 degrees.

In some embodiments, a splitting ratio between the undiffracted beam and the single diffracted beam may range from 0 to 100 percent of a power of the input beam.

In some embodiments, the splitting ratio may be continuously tunable by adjusting an angle of the input face relative to the input beam.

In some embodiments, the splitting ratio may be continuously tunable by adjusting a wavelength of the input beam.

In some embodiments, the one or more VBGs may include a single VBG.

In some embodiments, the one or more VBGs may include a first VBG and a second VBG. A grating vector direction of the first VBG may be oriented along a first direction. A grating vector direction of the second VBG may be oriented along a second direction different than the first direction. The one or more diffracted beams may include two or more diffracted beams.

In some embodiments, the planes of refractive index variation of the first VBG and the planes of refractive index variation of the second VBG may have equivalent distributions along the respective grating vector directions. The one or more selected wavelengths reflected by the first VBG may be equal to the one or more selected wavelengths reflected by the second VBG.

In some embodiments, the first direction may be orthogonal to the second direction.

In some embodiments, the planes of refractive index variation of the first VBG and the planes of refractive index variation of the second VBG may have different distributions along the respective grating vector directions.

In some embodiments, the planes of refractive index variation of the first VBG and the planes of refractive index variation of the second VBG may have uniform periods along the respective grating vector directions. The one or more selected wavelengths reflected by the first VBG may be different than the one or more selected wavelengths reflected by the second VBG.

In some embodiments, the one or more VBGs may include a first VBG and a second VBG. The grating vector direction of the first VBG and the grating vector direction of the second VBG may be oriented along a common direction. The planes of refractive index variation of the first VBG and the planes of refractive index variation of the second VBG may have different distributions along the respective grating vector directions. The one or more selected wavelengths reflected by the first VBG may be different than the one or more selected wavelengths reflected by the second VBG. The one or more diffracted beams may include two or more diffracted beams.

In some embodiments, the material may further include an output face. The undiffracted beam may exit through the output face.

In some embodiments, at least one of the one or more diffracted beams may exit through the output face.

In some embodiments, the material may further include an additional output face at an angle with respect to the input face. At least one of the one or more diffracted beams may exit from the additional output face.

In some embodiments, the light source providing the input beam may be a tunable light source.

In some embodiments, the light source providing the input beam may be a broadband source with a narrowband filter.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1 illustrates a perspective view of a beamsplitter with a single volume Bragg grating (VBG) within the volume of a material, in accordance with one or more embodiments of the present disclosure.

FIG. 2A is a plot of diffraction efficiency of a transmissive VBG as a function of angle, in accordance with one or more embodiments of the present disclosure.

FIG. 2B is a simplified block diagram view of a beamsplitter including a rotational translation stage configured to adjust an angular orientation of a material including a VBG, in accordance with one or more embodiments of the present disclosure.

FIG. 3 is a simplified block diagram view of a beamsplitter including a tunable illumination source and a material including a VBG, in accordance with one or more embodiments of the present disclosure.

FIG. 4 is a simplified block diagram view of a beamsplitter including two VBGs within the volume of a material, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods providing an optical beamsplitter formed from one or more volume Bragg gratings VBGs. In embodiments, an optical beamsplitter includes one or more VBGs within a volume of a material (e.g., a bulk material). The VBGs may be any type of VBGs known in the art including, but not limited to, transmissive VBGs, reflective VBGs, or a combination thereof.

VBGs are generally described in Igor V. Ciapurin, et al., “Modeling of phase volume diffractive gratings, part 1: transmitting sinusoidal uniform gratings,” Optical Engineering 45 (2006) 015802, 1-9; and Igor V. Ciapurin, et al., “Modeling of phase volume diffractive gratings, part 2: reflecting sinusoidal uniform gratings, Bragg mirrors,” Optical Engineering 51 (2012) 058001, 1-10, both of which are incorporated herein by reference in their entireties. Further, transmissive VBGs (e.g., VBGs for which light satisfying a Bragg condition is diffracted as a transmitted beam) configured as transmissive phase masks are described generally in U.S. Patent Publication No. 2016/0116656 published on Apr. 28, 2016, which is incorporated herein by reference in its entirety.

Light propagating through a VBG may be diffracted (e.g., as a diffracted beam) if conditions for Bragg diffraction are met and pass through undiffracted (e.g., as an undiffracted beam) otherwise. It is contemplated herein that a VBG may produce both a diffracted beam and an undiffracted beam (e.g., operate as a beamsplitter) when the properties of the VBG and the incident light provide that the diffraction efficiency of the VBG is between 0% and 100% (e.g., between 0 percent and 100 percent).

For example, a peak diffraction efficiency of a VBG may depend on various parameters such as, but not limited to, a grating length, a refractive index contrast (e.g., a difference between maximum and minimum values of refractive index), or a uniformity of a refractive index variation. In cases where the peak diffraction efficiency is less than 100%, input light incident on a VBG under conditions that satisfy conditions for Bragg diffraction will produce a diffracted beam and an undiffracted beam, where a power ratio between the two depends on the peak diffraction efficiency of the VBG. It is contemplated herein that the peak diffraction efficiency of a VBG may approach 100% such that a beamsplitter incorporating a VBG may provide a tunable power within a diffracted beam ranging from 0% (e.g., no power in the diffracted beam) to 100% (all or substantially all power in the undiffracted beam).

As another example, the diffraction efficiency of light through a VBG may be less than 100% when the properties of the VBG and the incident light slightly deviate from the conditions for Bragg diffraction. It is contemplated herein that the conditions for Bragg diffraction depend on properties such as wavelength and an incidence angle of light on the VBG. As a result, tuning the wavelength and/or the incidence angle slightly away from peak conditions satisfying Bragg diffraction may decrease diffraction efficiency and thus decrease a power in a diffracted beam relative to an undiffracted beam. More generally, the diffraction efficiency of a VBG may be expressed as continuous function of wavelength and/or incidence angle such that the power in a diffracted beam (e.g., and thus a power ratio between the diffracted beam and an undiffracted beam) may be tuned along this continuous function.

In some embodiments, a beamsplitter includes multiple VBGs within a material (e.g., a bulk material), which is referred to herein as multiplexed VBGs. Each of the VBGs may have different properties such as, but not limited to, grating vector direction or refractive index contrast. Further, any number of VBGs may be fabricated within a common volume of a material. In this way, an optical beamsplitter with multiple VBGs may potentially provide additional diffracted beams and/or additional flexibility for tuning the power ratios between any diffracted and undiffracted beams.

It is contemplated that a beamsplitter disclosed herein may operate with continuous-wave and/or pulsed light sources. It is further contemplated herein that a beamsplitter disclosed herein may be well suited for, but not limited to, tunable splitting of input beams with high powers (e.g., kW power levels or higher) due to the high damage thresholds of VBGs.

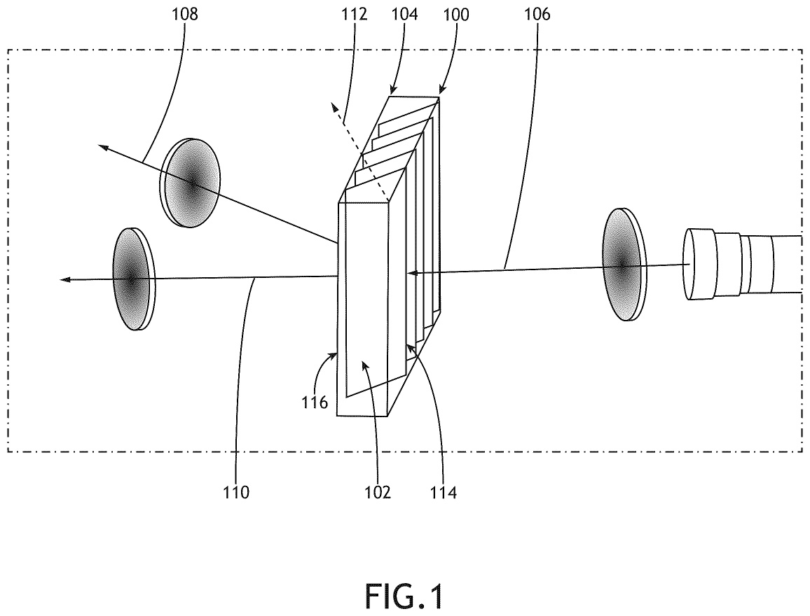

Referring now to FIGS. 1-4, systems and methods providing an optical beamsplitter are described in greater detail, in accordance with one or more embodiments of the present disclosure.

FIG. 1 illustrates a perspective view of a beamsplitter 100 with a single VBG 102 within the volume of a material 104, in accordance with one or more embodiments of the present disclosure. In FIG. 1, a portion of an input beam 106 (e.g., input light) incident on a VBG 102 is diffracted (e.g., via Bragg diffraction) as a diffracted beam 108 and a portion of the input beam 106 propagates through the VBG 102 undiffracted as an undiffracted beam 110.

A VBG 102 may be formed as a grating structure associated within the volume of material 104 (e.g., a bulk material) with a periodic variation of refractive index along a grating vector direction 112 (e.g., planes of refractive index variation), where the grating vector direction 112 may be represented as k=2π/d. The material 104 may include a photosensitive material or any other suitable material such as, but not limited to, a glass, a crystal, a polymer, or a sol-gel. Further, the refractive index variation forming a VBG 102 may be fabricated using any technique known in the art including, but not limited to, exposing the material 104 to an interference pattern and optional post-processing (e.g., heating) to induce the refractive index variation.

This grating structure is typically extended in directions perpendicular to the grating vector direction 112. Put another way, a VBG 102 may typically have a constant refractive index within any plane normal to the grating vector direction 112, where the refractive index along the grating vector direction 112 varies periodically. Further, a VBG 102 may generally have any selected variation of the refractive index along the grating vector direction 112 so long as a Bragg condition is satisfied for at least one wavelength in at least a portion of the VBG 102. For example, the refractive index n of a VBG 102 may be a simple sinusoidal function with a constant (e.g., uniform) period along the grating vector direction 112. In a case where the grating vector direction 112 corresponds to a Z direction, the refractive index variation may be characterized as:

$$n ( z ) = {n}_{0} + δ n cos ( \frac{2 π}{{Λ}_{0}} \cdot z ) , \qquad ( 1 )$$

where n₀ is an average refractive index of a material 104 in which the VBG 102 is formed, &n is a refractive index contrast, and Ao is a period of the refractive index variation along the grating vector direction 112.

It is noted that the figures depict variations of refractive index along the grating vector direction 112 as simple lines or planes, but this is merely illustrative and should not be interpreted as limiting the scope of the present disclosure. Similarly, it is to be understood that Equation (1) is merely illustrative and should not be interpreted as limiting the scope of the present disclosure. Rather, an VBG 102 may include any refractive index distribution suitable for reflecting light via Bragg reflection.

It is contemplated herein that the material 104 of a beamsplitter 100 in which a VBG 102 is formed may have any shape and/or any number of faces at any orientation with respect to the grating vector direction 112. For example, a VBG may receive the input beam 106 through an input face 114. As another example, the undiffracted beam 110 and any number of diffracted beams 108 may exit the VBG 102 from any number of output faces 116, which may be the same as or different than the input face 114.

The input face input face 114 and/or any output faces 116 of the material 104 may be arranged at any angles with respect to input or output light. For example, the material 104 may be configured to provide that the input beam 106 enters the input face 114 at a normal incidence angle in one configuration. Similarly, the material 104 may be configured without one or more output faces 116 arranged to provide that at least one output beam (e.g., an undiffracted beam 110 and/or any of the diffracted beams 108) exits an output face 116 at a normal angle in at least one configuration. However, these are merely illustrations and not requirements. The input beam 106 may enter an input face 114 at any angle. Similarly, the undiffracted beam 110 and/or any of the diffracted beams 108 may exit any particular output face 116 at any angle.

Further, the VBG 102 may operate as a transmissive element (e.g., in which a diffracted beam 108 corresponds to a transmitted diffraction order) or a reflective element (e.g., in which a diffracted beam 108 corresponds to a reflected diffraction order). As an illustration, FIG. 1 depicts a non-limiting configuration of a VBG 102 having a grating vector direction 112 oriented at a non-zero angle with respect to an input face 114 of the material 104 and where the VBG 102 operates as a transmissive element. In this configuration, the input beam 106 enters the material 104 through the input face 114 and both the undiffracted beam 110 and the diffracted beam 108 exit the material 104 from a common output face 116 that is parallel to the input face 114.

However, it is to be understood that FIG. 1 is provided solely for illustrative purposes and should not be interpreted as limiting the scope of the present disclosure. In a general sense, the grating vector direction 112 may be oriented at any angle θ relative to an input face 114 such that 0°≤θ≤90°. Further, the material 104 including a VBG 102 may include any number of output faces 116 oriented at any angles with respect to the undiffracted beam 110 or the diffracted beam 108.

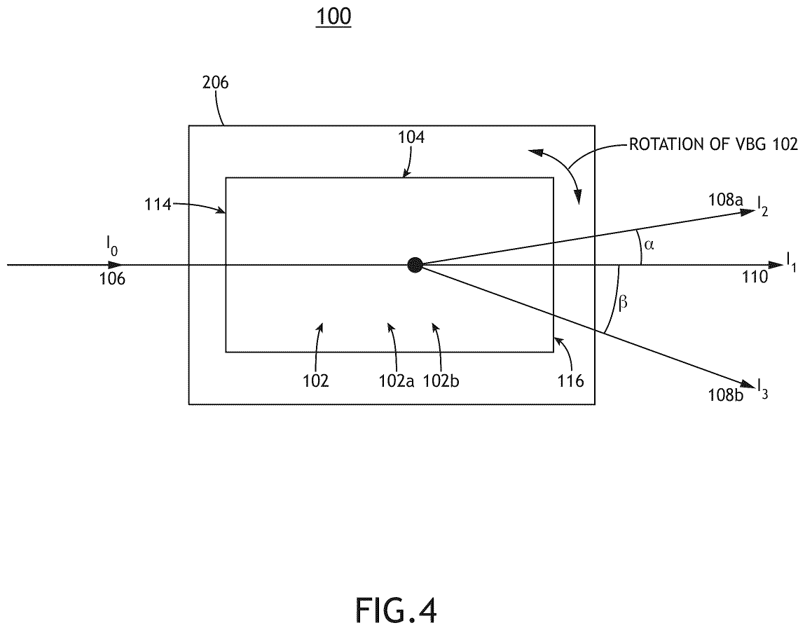

Although not explicitly shown in FIG. 1, a beamsplitter 100 may include any number of VBGs 102 within the volume of a material 104 (e.g., may include any number of multiplexed VBGs 102) within a material 104. In this configuration, each VBG 102 may have different properties such as, but not limited to, a period of refractive index variation (e.g., Λ₀ in Equation (1)), a refractive index contrast (e.g., δn in Equation (1)), or a grating vector direction 112. Multiplexed VBGs 102 are further described with respect to FIG. 4.

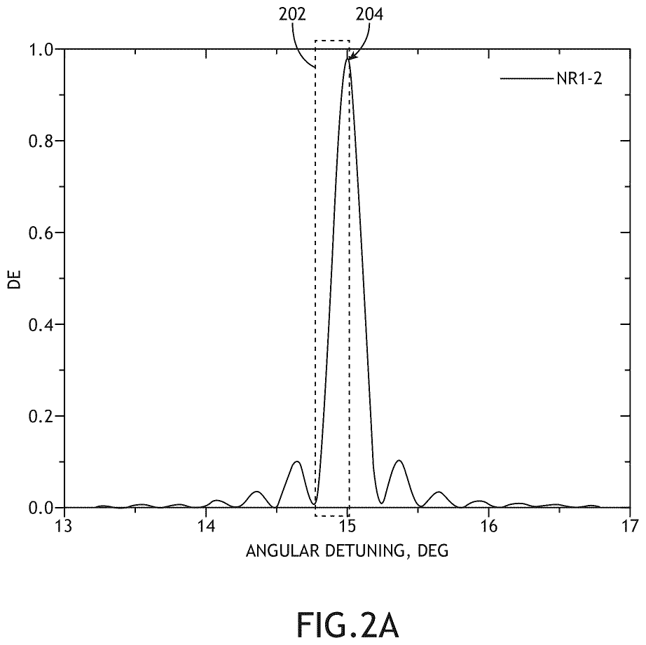

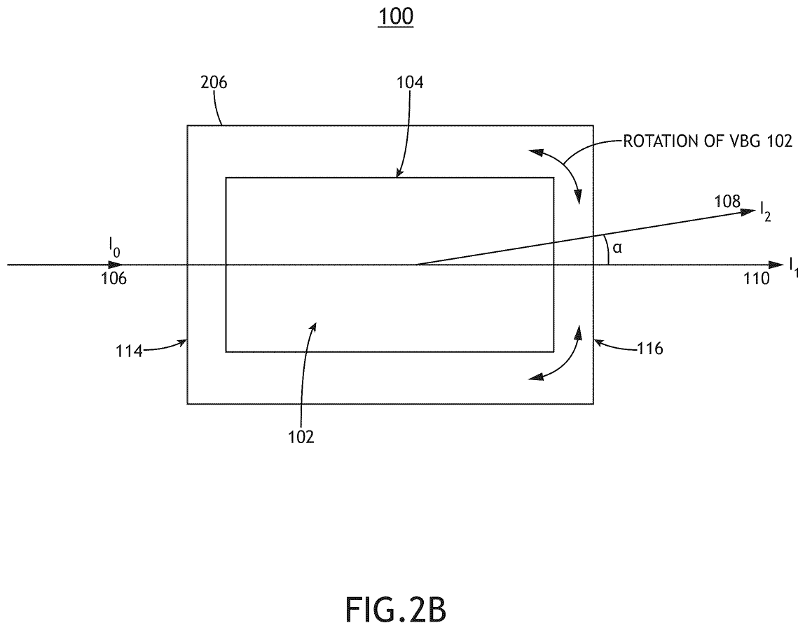

Referring now to FIGS. 2A-4, the power ratio between a diffracted beam 108 and an undiffracted beam 110 is described in greater detail, in accordance with one or more embodiments of the present disclosure.

In a general sense, the power of a diffracted beam 108 generated by a particular VBG 102 relative to a power of an input beam 106 is controlled by a diffraction efficiency of the VBG 102 for the input beam 106, which depends on parameters such as, but not limited to, the wavelength of the input beam 106, the period of the VBG 102, the incidence angle of the input beam 106 on the VBG 102 (e.g., with respect to the grating vector direction 112), or the refractive index contrast of the VBG 102. Further, this diffraction efficiency may be tuned by adjusting the wavelength and/or the incidence angle of the input beam 106 across a range around conditions associated with Bragg diffraction. As a result, a splitting ratio associated with relative powers of the diffracted beam 108 and the undiffracted beam 110 provided by the beamsplitter 100 may be tuned by adjusting the wavelength and/or the incidence angle of the input beam 106 across a range around conditions associated with Bragg diffraction.

FIGS. 2A-2B depict angular tuning of a beamsplitter 100, in accordance with one or more embodiments of the present disclosure. FIG. 2A is a plot of diffraction efficiency (DE) of a transmissive VBG 102 (e.g., as depicted in FIG. 1) as a function of angle, in accordance with one or more embodiments of the present disclosure. In this way, FIG. 2A depicts angular tuning (or angular detuning) of a transmissive VBG 102. In FIG. 2A, the VBG 102 and the input beam 106 are designed such that conditions for Bragg diffraction are satisfied with an incidence angle of 15 degrees. As seen in FIG. 2A, the diffraction efficiency has a continuous distribution with a peak value of 99.9% at an incidence angle of 15 degrees. Further, there exists a transition region 202 on either side of the peak 204 in which the diffraction efficiency transitions between the peak value and a minimum value (here around 0%). Accordingly, the diffraction efficiency and thus the splitting ratio of the beamsplitter 100 may be continuously tuned by adjusting the incidence angle within this transition region 202.

The incidence angle of the input beam 106 on the VBG 102 may be adjusted through control of the input face 114 and/or the VBG 102.

FIG. 2B is a simplified block diagram view of a beamsplitter 100 including a rotation stage 206 configured to adjust an angular orientation of a material 104 including a VBG 102, in accordance with one or more embodiments of the present disclosure. It is noted that the VBG 102 is not depicted within the material 104 in FIG. 2B for clarity of illustration.

As illustrated in FIG. 2B, a material 104 including a VBG 102 may be mounted to (e.g., secured to) the rotation stage 206. In this configuration, a path of the input beam 106 may be fixed and the incidence angle of the input beam 106 on an input face 114 of the material 104 (and thus the VBG 102) may be adjusted by translation of the rotation stage 206.

FIG. 2B further depicts an undiffracted beam 110 (I₁) and a diffracted beam 108 (I₂) exiting the material 104 with an angular separation (α) relative to the undiffracted beam 110 governed by the Bragg diffraction angle. In a general sense, the VBG 102 within the material 104 may be designed as either a transmissive element (e.g., as shown in FIG. 2B) or a reflective element to provide any angular separation (α) between 0° to 180°, where 0 angle is when the beams coincide with the initial propagation direction and 180 degrees is a beam is back reflected in direction exactly opposite to the initial propagation direction. In some applications, an angular separation between the undiffracted beam 110 and the diffracted beam 108 is selected to be 45 degrees or any other selected value.

Further, as depicted in FIG. 2A, the input power (I₀) of an input beam 106 may be selectively split between the undiffracted beam 110 (I₁) and the diffracted beam 108 (I₂) at any splitting ratio (e.g., power ratio) by adjusting the angular position of the material 104 with the rotation stage 206 through the transition region 202. In this way, the power within undiffracted beam 110 (I₁) and the diffracted beam 108 (I₂) may each be smoothly adjusted between 0 and I₀ (e.g., between 0% and 100% of I₀). For example, the splitting ratio between the undiffracted beam 110 and the diffracted beam 108 may be adjusted to be 50:50 (e.g., equivalent power in both beams) or any other desired splitting ratio.

It is to be understood that FIGS. 2A and 2B are provided solely for illustrative purposes and should not be interpreted as limiting the scope of the present disclosure. For example, the material 104 may have any shape and any number of faces.

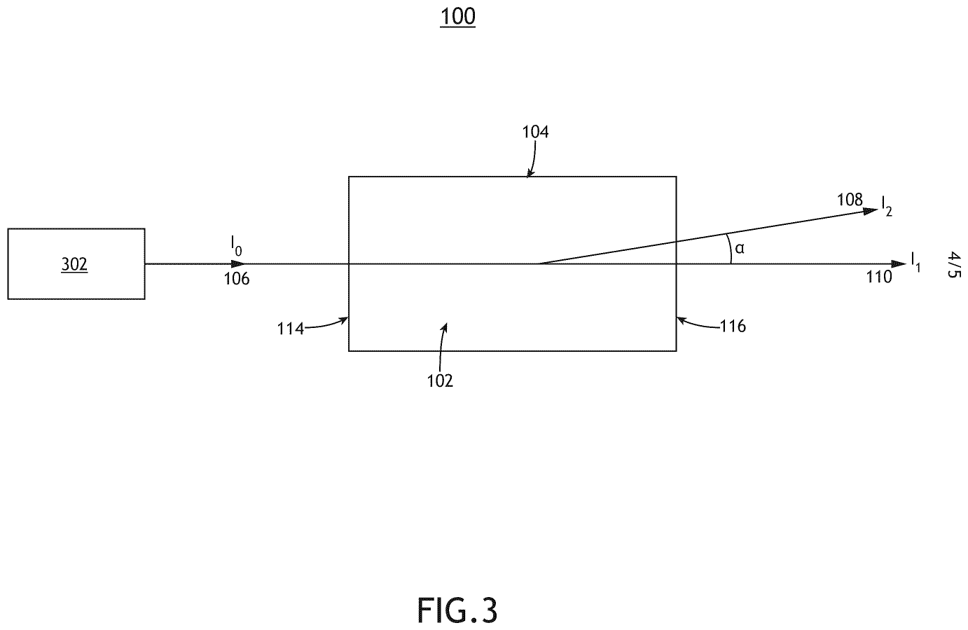

Referring now to FIG. 3, wavelength tuning of a beamsplitter 100 with a VBG 102 is described in greater detail, in accordance with one or more embodiments of the present disclosure. FIG. 3 is a simplified block diagram view of a beamsplitter 100 including a tunable illumination source 302 and a material 104 including a VBG 102, in accordance with one or more embodiments of the present disclosure. It is noted that the VBG 102 is not depicted within the material 104 in FIG. 3 for clarity of illustration.

It is contemplated herein that the diffraction efficiency of a VBG 102 may be spectrally tuned in a manner similar to angular tuning shown in FIGS. 2A-2B. For example, the diffraction efficiency of the VBG 102 may have a peak value associated with a particular wavelength and a transition region on either side of the peak value such that the power of a diffracted beam 108 (and thus a splitting ratio between a diffracted beam 108 and an undiffracted beam 110) may be tuned by adjusting the wavelength of the input beam 106 through the transition region.

The tunable illumination source 302 may include any source suitable for generating an input beam 106 having a tunable spectrum such as, but not limited to, a laser source, a light emitting diode (LED) source, or a lamp source. In some embodiments, the tunable illumination source 302 is directly tunable to selectively produce an input beam 106 with tunable wavelengths (e.g., a tunable laser source, or the like). In some embodiments, the tunable illumination source 302 is a broadband source providing an input beam 106 with a broad spectrum, where the tunable illumination source 302 may further include a narrowband filter (e.g., a tunable spectral filter) to selectively narrow the spectrum of the input beam 106.

Referring now to FIG. 4, a beamsplitter 100 with multiplexed VBGs 102 is described in greater detail, in accordance with one or more embodiments of the present disclosure.

As described previously herein, a beamsplitter 100 may include multiple VBGs 102 within the volume of a material 104 (e.g., multiplexed VBGs 102). It is contemplated herein that each of the multiplexed VBGs 102 may generate a diffracted beam 108 when an input beam 106 satisfies the conditions for Bragg diffraction. In this way, the descriptions associated with angular and wavelength tuning of one VBG 102 in FIGS. 2A-3 may extend to any of the multiplexed VBGs 102.

A beamsplitter 100 formed with one or more VBGs 102 may thus potentially produce one or more associated with Bragg diffraction of portions of the input beam 106 by any of the one or more VBGs 102 as well as an undiffracted beam 110 associated with an undiffracted portion of the input beam 106, where a power in each of the one or more diffracted beams 108 is controlled by the diffraction efficiencies of each of the one or more VBGs 102 for the input beam 106.

It is contemplated herein that a material 104 may include multiplexed VBGs 102 with a wide range of configurations. For example, multiplexed VBGs 102 may include grating vector directions 112 that are the same (e.g., uniform) or are different directions. As an illustration, a material 104 may include a first VBG 102 with a first grating vector direction 112 along a first direction and a second VBG with a second grating vector direction 112 along a second direction. In some cases, the first grating vector direction 112 is the same as the second grating vector direction 112. In some cases, the first grating vector direction 112 is different than the second grating vector direction 112. Further, the first grating vector direction 112 and the second grating vector direction 112 may be separated by any angle from 0 degrees to 90 degrees (e.g., orthogonal).

As another example, multiplexed VBGs may have the same (e.g., uniform) or different refractive index distributions along respective grating directions. As used herein, a refractive index distribution or a distribution of planes of refractive index variation may refer to properties of the VBG 102 that control a Bragg diffraction angle and/or a Bragg efficiency such as, but not limited to, an average refractive index of a material 104 (no), a refractive index contrast (on), or a period of the refractive index variation Ao) along the grating vector direction 112.

Continuing the illustrations above, the first VBG 102 may have a first distribution of planes of refractive index variation (oriented along the first direction) and the second VBG 102 may have a second distribution of planes of refractive index variation (oriented along the second direction). In some cases, the first distribution is the same as the second distribution (e.g., the distributions may be uniform) such that the first VBG 102 and the second VBG 102 may diffract the same wavelengths (e.g., equal wavelengths) at a given incidence angle. In some cases, the first distribution is different than the second distribution such that the first VBG 102 and the second VBG 102 may diffract different wavelengths at a given incidence angle.

Accordingly, multiplexed VBGs 102 may have any combination of grating vector directions 112 and refractive index distributions. In this way, selected performance utilizing any combination of angular tuning and/or spectral tuning may be achieved.

However, in configurations in which multiplexed VBGs 102 have a common grating vector direction 112, it may be beneficial that the VBSs have different refractive index distributions (e.g., different periods) to provide differentiated performance. For example, in some embodiments, a material 104 may include multiplexed VBGs having a common grating vector direction 112 but different periods to provide different Bragg diffraction angles.

FIG. 4 is a simplified block diagram view of a beamsplitter 100 including two VBGs 102 (labeled as 102a and 102b) within the volume of a material 104, in accordance with one or more embodiments of the present disclosure. It is noted that the planes of refractive index variation associated with the multiplexed VBGs 102a, 102b are not depicted within the material 104 in FIG. 4 for clarity of illustration.

In FIG. 4, an input beam 106 may be selectively split between an undiffracted beam 110 (I₁), a first diffracted beam 108a (I₂) associated with Bragg diffraction from a first VBG 102a at a first angle (α) with respect to the undiffracted beam 110, and a second diffracted beam 108b (I₃) associated with Bragg diffraction from a second VBG 102b second angle (β) with respect to the undiffracted beam 110. The first diffracted beam 108a and the second diffracted beam 108b may each be transmissive elements or reflective elements such that the angles α and β may range from 0° to 180°.

Additionally, a power in each of the diffracted beams 108 may be tuned between 0 and I₀ through any combination of angular tuning (e.g., as shown in FIG. 4) or spectral tuning. For example, each one of the VBGs 102a, 102b could be designed to operate with the same input beam direction but different wavelengths of light. In this way, spectral tuning of the input beam 106 may selectively transition the power between the undiffracted beam 110 and different diffracted beams 108. As another example, different VBGs 102 may be individually addressed by multiple input beams (not shown) from different directions with the same or different wavelengths.

Referring now generally to FIGS. 1-4, the diffraction efficiency of a VBG 102 may further depend on the polarization state of the input beam 106. For example, polarization-sensitive operation of VBGs is generally described in U.S. Patent Publication No. 2024/0192420 published on Jun. 13, 2024, which is incorporated herein by reference in its entirety. In such configurations, the splitting ratio between an undiffracted beam 110 and a diffracted beam 108 may further be tuned by adjusting a polarization of the input beam 106 relative to a VBG 102.

Further referring generally to FIGS. 1-4, various aspects of the present disclosure are described.

The present disclosure provides an optical beamsplitter 100 comprising a light source 302 providing an input beam 106, one or more VBGs (volume Bragg gratings) 102 within a volume of a material 104 having an input face 114, and a rotation stage 206 configured to secure the volume of the material 104 and adjust an incidence angle of the input beam 106 on the input face 114. Each of the one or more VBGs 102 is formed as planes of refractive index variation with periodicity along a grating vector direction 112 at a non-zero angle relative to a normal vector of the input face 114, and the material 104 receives the input beam 106 through the input face 114. At least a portion of the input beam 106 is directed into one or more diffracted beams 108 when a Bragg condition is satisfied for any of the one or more VBGs 102, while at least a portion of the input beam 106 undiffracted by the one or more VBGs 102 forms an undiffracted beam 110. The power distribution between the undiffracted beam 110 and the one or more diffracted beams 108 is adjustable by controlling the incidence angle with the rotation stage 206.

In some embodiments, the power of the one or more diffracted beams 108 is associated with a diffraction efficiency of the one or more VBGs 102. The one or more diffracted beams 108 may comprise a single diffracted beam 108, where an angle formed between the undiffracted beam 110 and the single diffracted beam 108 ranges from 0 degrees to 180 degrees. A splitting ratio between the undiffracted beam 110 and the single diffracted beam 108 may range from 0 to 100 percent of a power of the input beam 106. This splitting ratio can be continuously tunable by adjusting an angle of the input face 114 relative to the input beam 106 or by adjusting a wavelength of the input beam 106.

In some configurations, the one or more VBGs 102 comprise a single VBG 102. In other configurations, the one or more VBGs 102 comprise a first VBG 102a with a grating vector direction 112 oriented along a first direction, and a second VBG 102b with a grating vector direction 112 oriented along a second direction different than the first direction. In this case, the one or more diffracted beams 108 comprise two diffracted beams 108a, 108b. The planes of refractive index variation of the first VBG 102a and the second VBG 102b may have equivalent distributions along the respective grating vector directions 112, or they may have different distributions. In some cases, the first direction is orthogonal to the second direction. The planes of refractive index variation of the first VBG 102a and the second VBG 102b may have uniform periods along the respective grating vector directions 112.

Alternatively, the one or more VBGs 102 may comprise a first VBG 102a and a second VBG 102b, where the grating vector direction 112 of the first VBG 102a and the grating vector direction 112 of the second VBG 102b are oriented along a common direction. In this case, the planes of refractive index variation of the first VBG 102a and the second VBG 102b have different distributions along the respective grating vector directions 112, and the one or more diffracted beams 108 comprise two or more diffracted beams 108a, 108b.

The material 104 may further include an output face 116, where the undiffracted beam 110 exits through the output face 116. At least one of the one or more diffracted beams 108 may also exit through the output face 116. In some embodiments, the material 104 further includes an additional output face 116 at an angle with respect to the input face 114, where at least one of the one or more diffracted beams 108 exit from the additional output face 116.

The present disclosure also provides an optical beamsplitter 100 comprising one or more VBGs 102 within a volume of a material 104 having an input face 114, and a light source 302 providing an input beam 106 with a tunable wavelength. The material 104 receives the input beam 106 through the input face 114, and at least a portion of the input beam 106 is diffracted as one or more diffracted beams 108 when a Bragg condition is satisfied for any of the one or more VBGs 102. At least a portion of the input beam 106 undiffracted by the one or more VBGs 102 forms an undiffracted beam 110. The power distribution between the undiffracted beam 110 and the one or more diffracted beams 108 is adjustable by controlling the wavelength of the input beam 106 with the light source 302.

Similar to the previous embodiment, the power of the one or more diffracted beams 108 is associated with a diffraction efficiency of the one or more VBGs 102. The one or more diffracted beams 108 may comprise a single diffracted beam 108, with an angle formed between the undiffracted beam 110 and the single diffracted beam 108 ranging from 0 to 180 degrees. A splitting ratio between the undiffracted beam 110 and the single diffracted beam 108 may range from 0 to 100 percent of a power of the input beam 106, and this splitting ratio can be continuously tunable by adjusting an angle of the input face 114 relative to the input beam 106 or by adjusting the wavelength of the input beam 106.

The one or more VBGs 102 may comprise a single VBG 102 or multiple VBGs 102a, 102b with various configurations, similar to the previous embodiment. The material 104 may include output faces 116 through which the undiffracted beam 110 and diffracted beams 108 exit, as described earlier.

The light source 302 providing the input beam 106 may be a tunable light source 302 or a broadband source with a narrowband filter.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. An optical beamsplitter comprising:
a light source providing an input beam;
one or more VBGs (volume Bragg gratings) within a volume of a material having an input face, wherein each of the one or more VBGs is formed as planes of refractive index variation with periodicity along a grating vector direction at a non-zero angle relative to a normal vector of the input face, wherein the material receives the input beam through the input face; and
a rotation stage configured to secure the volume of the material and adjust an incidence angle of the input beam on the input face, wherein at least a portion of the input beam is directed into one or more diffracted beams when a Bragg condition is satisfied for any of the one or more VBGs, wherein at least a portion of the input beam undiffracted by the one or more VBGs forms an undiffracted beam, wherein an power distribution between the undiffracted beam and the one or more diffracted beams is adjustable by controlling the incidence angle with the rotation stage.

2. The optical beamsplitter of claim 1, wherein a power of the one or more diffracted beams is associated with a diffraction efficiency of the one or more VBGs.

3. The optical beamsplitter of claim 1, wherein the one or more diffracted beams comprise a single diffracted beam.

4. The optical beamsplitter of claim 3, wherein an angle formed between the undiffracted beam and the single diffracted beam ranges from 0 degrees to 180 degrees.

5. The optical beamsplitter of claim 3, wherein a splitting ratio between the undiffracted beam the single diffracted beam ranges from 0 to 100 percent of a power of the input beam.

6. The optical beamsplitter of claim 5, wherein the splitting ratio is continuously tunable by adjusting an angle of the input face relative to the input beam.

7. The optical beamsplitter of claim 5, wherein the splitting ratio is continuously tunable by adjusting a wavelength of the input beam.

8. The optical beamsplitter of claim 1, wherein the one or more VBGs comprise a single VBG.

9. The optical beamsplitter of claim 1, where the one or more VBGs comprise:
a first VBG, wherein the grating vector direction of the first VBG is oriented along a first direction; and
a second VBG, wherein the grating vector direction of the second VBG is oriented along a second direction different than the first direction, wherein the one or more diffracted beams comprise two diffracted beams.

10. The optical beamsplitter of claim 9, wherein the planes of refractive index variation of the first VBG and the planes of refractive index variation of the second VBG have equivalent distributions along the respective grating vector directions.

11. The optical beamsplitter of claim 9, wherein the first direction is orthogonal to the second direction.

12. The optical beamsplitter of claim 9, wherein the planes of refractive index variation of the first VBG and the planes of refractive index variation of the second VBG have different distributions along the respective grating vector directions.

13. The optical beamsplitter of claim 11, wherein the planes of refractive index variation of the first VBG and the planes of refractive index variation of the second VBG have uniform periods along the respective grating vector directions.

14. The optical beamsplitter of claim 1, wherein the one or more VBGs comprise:
a first VBG; and
a second VBG, wherein the grating vector direction of the first VBG and the grating vector direction of the second VBG are oriented along a common direction, wherein the planes of refractive index variation of the first VBG and the planes of refractive index variation of the second VBG have different distributions along the respective grating vector directions, wherein the one or more diffracted beams comprise two or more diffracted beams.

15. The optical beamsplitter of claim 1, wherein the material further includes an output face, wherein the undiffracted beam exits through the output face.

16. The optical beamsplitter of claim 15, wherein at least one of the one or more diffracted beams exits through the output face.

17. The optical beamsplitter of claim 15, wherein the material further includes an additional output face at an angle with respect to the input face, wherein at least one of the one or more diffracted beams exit from the additional output face.

18. An optical beamsplitter comprising:
one or more VBGs (volume Bragg gratings) within a volume of a material having an input face, wherein each of the one or more VBGs is formed as planes of refractive index variation with periodicity along a grating vector direction at a non-zero angle relative to a normal vector of the input face, wherein the material receives an input beam through the input face; and
a light source providing the input beam, wherein a wavelength of the input beam is tunable to one or more selected wavelengths, wherein at least a portion of the input beam is diffracted as one or more diffracted beams when a Bragg condition is satisfied for any of the one or more VBGs, wherein at least a portion of the input beam undiffracted by the one or more VBGs forms an undiffracted beam, wherein an power distribution between the undiffracted beam and the one or more diffracted beams is adjustable by controlling the wavelength of the input beam with the light source.

19. The optical beamsplitter of claim 18, wherein a power of the one or more diffracted beams is associated with a diffraction efficiency of the one or more VBGs.

20. The optical beamsplitter of claim 18, wherein the one or more diffracted beams comprise a single diffracted beam.

21. The optical beamsplitter of claim 20, wherein an angle formed between the undiffracted beam and the single diffracted beam ranges from 0 to 180 degrees.

22. The optical beamsplitter of claim 20, wherein a splitting ratio between the undiffracted beam the single diffracted beam ranges from 0 to 100 percent of a power of the input beam.

23. The optical beamsplitter of claim 22, wherein the splitting ratio is continuously tunable by adjusting an angle of the input face relative to the input beam.

24. The optical beamsplitter of claim 22, wherein the splitting ratio is continuously tunable by adjusting a wavelength of the input beam.

25. The optical beamsplitter of claim 18, wherein the one or more VBGs comprise a single VBG.

26. The optical beamsplitter of claim 18, where the one or more VBGs comprise:
a first VBG, wherein a grating vector direction of the first VBG is oriented along a first direction; and
a second VBG, wherein a grating vector direction of the second VBG is oriented along a second direction different than the first direction, wherein the one or more diffracted beams comprise two or more diffracted beams.

27. The optical beamsplitter of claim 26, wherein the planes of refractive index variation of the first VBG and the planes of refractive index variation of the second VBG have equivalent distributions along the respective grating vector directions, wherein the one or more selected wavelengths reflected by the first VBG are equal to the one or more selected wavelengths reflected by the second VBG.

28. The optical beamsplitter of claim 26, wherein first direction is orthogonal to the second direction.

29. The optical beamsplitter of claim 26, wherein the planes of refractive index variation of the first VBG and the planes of refractive index variation of the second VBG have different distributions along the respective grating vector directions.

30. The optical beamsplitter of claim 26, wherein the planes of refractive index variation of the first VBG and the planes of refractive index variation of the second VBG have uniform periods along the respective grating vector directions, wherein the one or more selected wavelengths reflected by the first VBG are different than the one or more selected wavelengths reflected by the second VBG.

31. The optical beamsplitter of claim 18, wherein the one or more VBGs comprise:
a first VBG; and
a second VBG, wherein the grating vector direction of the first VBG and the grating vector direction of the second VBG are oriented along a common direction, wherein the planes of refractive index variation of the first VBG and the planes of refractive index variation of the second VBG have different distributions along the respective grating vector directions, wherein the one or more selected wavelengths reflected by the first VBG are different than the one or more selected wavelengths reflected by the second VBG, wherein the one or more diffracted beams comprise two or more diffracted beams.

32. The optical beamsplitter of claim 18, wherein the material further includes an output face, wherein the undiffracted beam exits through the output face.

33. The optical beamsplitter of claim 32, wherein at least one of the one or more diffracted beams exits through the output face.

34. The optical beamsplitter of claim 32, wherein the material further includes an additional output face at an angle with respect to the input face, wherein at least one of the one or more diffracted beams exit from the additional output face.

35. The optical beamsplitter of claim 18, wherein the light source providing the input beam is a tunable light source.

36. The optical beamsplitter of claim 18, wherein the light source providing the input beam is a broadband source with a narrowband filter.
